(19) United States
(12) Patent Application Publication
(10) Pub. No.: US 2011/0214581 A1
(43) Pub. Date: Sep. 8, 2011

(54) OPERATION OF A COLD FILM UNIT WITH GLUE APPLICATION

(75) Inventors: Uwe Puschel, Heidesheim (DE); Jürgen Schölzig, Mainz (DE); Wolfgang Treiss, Weingarten (DE)

(73) Assignee: manroland AG, Offenbach (DE)

(21) Appl. No.: 12/994,664

(22) PCT Filed: May 6, 2009
(86) PCT No.: PCT/EP2009/055452

§ 371 Date: May 20, 2011

(30) Foreign Application Priority Data
May 28, 2008 (DE) 102008002044.3
May 5, 2009 (DE) 102009002822.6

(51) Int. Cl. B41F 5/16

(52) U.S. Cl. 101/177

(57) ABSTRACT

The invention relates to a unit for cold film transfer in a printing press. In order to improve the transfer process, a control device is used to control the film transfer, said control device adjusting the color values and the coating parameters of the transferred films.

### CROSS-REFERENCE TO RELATED APPLICATIONS

This patent application is the national phase of PCT/EP2009/055452, filed May 6, 2009, which claims the benefit of German Patent Application Nos. 10 2008 002 044.3, filed May 28, 2008, and 10 2009 002 822.6, filed May 5, 2009.

### FIELD OF THE INVENTION

The present invention relates generally to printing machines, and more particularly to printing machines having a printing unit operable for transferring imaging layers from a carrier film onto printing sheets.

### BACKGROUND OF THE INVENTION

It is known to produce metallic layers on printing sheets by means of a film-transfer method. For example, in EP 0 569 520 B1, a sheet-processing machine is shown that has feed and delivery assemblies, wherein printing units and a coating unit are arranged between those assemblies. An adhesive pattern is deposited by means of a cold printing method in at least one of the printing units. This adhesive pattern has a certain imaging motif. A film guide is provided in a coating unit following the printing unit in which the adhesive pattern is applied. This guide is designed such that a film strip or a transfer film is guided from a film storage roll through a transfer gap of the coating unit defined between an impression cylinder and a pressure roller. The film strip is wound up again on a delivery side after leaving the coating unit. The transfer film has a carrier layer on which imaging layers, such as metallic layers, for example, aluminum, are provided. An intermediate separation layer is provided that ensures that the metallic layer can be removed from the carrier layer.

During the transport of printing sheets through the printing unit, each printing sheet is provided with an adhesive pattern. Then the printing sheet is guided through the coating unit, wherein, by means of the pressure roller, the printing sheet lying on the impression cylinder is brought into contact with the film material. Here, the metallic layer enters into tight contact with the areas on the printing sheet provided with adhesive. After further transport of the printing sheet, the metallic layer adheres only in the area of the pattern provided with adhesive. The metallic layer is thus removed from the carrier film in the area of the adhesive pattern. The transfer film consumed in this way is wound up again and the printing sheet is delivered in the coated state.

It is known to use such coating units in printing units of printing presses. A disadvantage in known devices is that they often do not lend themselves to flexible and reliable usage. The process-defining parameters can be difficult to control depending on the load on the web or machine speed, the take-up ability of the film roll, changes in the web tension, variables of the application subject, and operation of a channel exciter. This can result that quality losses during the film transfer in the application process and errors in film application.

### OBJECTS AND SUMMARY OF THE INVENTION

It is an object of the invention to provide a device for more economically, efficiently, and reliably transferring imaging layers onto printing sheets.

In carrying out the invention, a printing unit that is arranged upstream of the coating unit for the film transfer as an application unit for adhesive, which includes a device for controlling the color density so that, in this application unit, favorable settings for the film transfer process can be effected in a simple way.

Therefore, a measurement of the adhesive application is added to the adjustment of the function of the application unit preceding the coating unit for the film transfer for expanding the function of the printing unit of the printing press during the film transfer. The adhesive is used like a printing ink and is measured on the printing sheet by means of a color density measurement system.

For this purpose special color measurement fields for the adhesive are provided for the film transfer. Furthermore, in the coating unit, the film transfer is effected so that no film transfer takes place in the areas of the measurement fields where adhesive is applied. Furthermore, the adhesive is colored with a special ink that is matched to the film to be transferred and simultaneously can be easily detected with measurement technology. The adhesive application can be easily controlled in this way and, if desired, can be regulated with respect to a required applied quantity.

The device can also be used advantageously even when the transfer film is divided into one or more sub-film webs of smaller width. In combination with the foregoing method, different types of films could also be used one next to the other.

Other objects and advantages of the invention will become apparent upon reading the following detailed description and upon reference to the drawings, in which:

### BRIEF DESCRIPTION OF THE DRAWINGS

FIG. 1 is a side elevational view of an illustrative printing machine having a film-transfer device in accordance with the invention;

FIG. 2 is a depiction of an illustrative printing press having a central control console that is operable in accordance with the invention;

FIG. 3 is a fragmentary vertical section of a cylinder of the illustrated printing machines with linings that can be scanned;

FIG. 4 is a diagrammatic depiction of an alternative embodiment of a printing machine in accordance with the invention; and

FIG. 5 is a top view of a printing sheet with film coatings and a color measurement control strip.

While the invention is susceptible of various modifications and alternative constructions, a certain illustrative embodiment thereof has been shown in the drawings and will be described below in detail. It should be understood, however, that there is no intention to limit the invention to the specific form disclosed, but on the contrary, the intention is to cover all modifications, alternative constructions, and equivalents falling within the spirit and scope of the invention.

### DESCRIPTION OF THE PREFERRED EMBODIMENTS

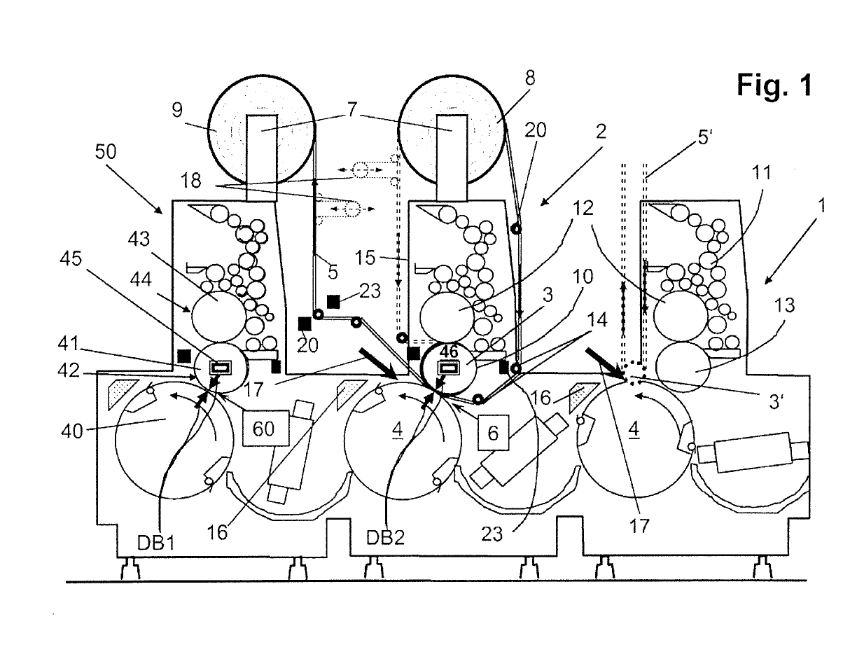

Referring now more particularly to FIG. 1 of the drawings, there is shown an illustrative sheet fed printing machine having a plurality of printing units. In a first printing unit (application unit 1) an imaging adhesive pattern is applied to the printing sheet. Then, in the following printing unit (coating unit 2), a transfer film 5 is guided together with the printing sheet through a transfer gap 6, wherein the transfer film 5 is pressed, in the transfer gap 6, against the printing sheet.

The application unit 1 may be a known offset printing unit with an inking unit 11, a plate cylinder 12, a blanket cylinder 13, and a sheet-guiding impression cylinder 4. This could likewise be a known type of coating module in which the blanket cylinder 13 is a form cylinder. The plate cylinder/form cylinder is provided with a bonding agent, such as a printing ink or adhesive, from a device constructed, e.g., as an ink-chamber blade system instead of the inking unit 11.

The transfer gap 6 in the coating unit 2 is formed by a pressure roller 3 and an impression cylinder 4. Here, the pressure roller 3 could correspond to a blanket cylinder and the impression cylinder 4 could correspond to an impression cylinder of an offset printing unit. Furthermore, the pressure roller 3 could correspond to the form cylinder and the impression cylinder 4 could correspond to the impression cylinder of a coating module of a sheet-fed printing press.

The transfer film has a multi-layer configuration, including a carrier layer on which an imaging layer is deposited by means of a separation layer. The separation layer is used to simplify lifting of the imaging layer from the carrier layer. The imaging layer could be, for example, a metallized layer, a glossy layer, a textured layer, a colored layer, or a layer containing one or more image patterns.

A film storage roll 8 and a film take-up roll 9 are provided for the coating unit 2 for film feeding and take-up. The film rolls 8, 9 each have a rotary drive 7 for the continuously regulated feeding of the transfer film 5 to the coating unit 2. Deflection or tensioning rollers are provided in the region of the film feeding so that the film web can always be kept at the same tension relative to the pressure roller 3. The transfer film 5 also could be moved essentially by the rotary drive 7 on the discharge side and could be kept taut on the feed side by means of a brake.

The transfer process of the imaging, e.g., metallized layer, onto the printing paper is effected in the transfer gap 6 between the pressure roller 3 and the impression cylinder 4.

Likewise, a pressure roller 3′ (see FIG. 1 in the application unit 1) could be arranged after the transfer gap between the blanket cylinder 13 and the impression cylinder 4 in adjacent relation to the impression cylinder 4. A transfer film 5′ also could be placed on a sheet held on the impression cylinder 4 by means of the pressure roller 3′, so that application of the imaging or metallization layer could take place there directly after the imaging adhesive application.

The pressure roller 3 is provided with a pressure lining 10, e.g., as a plastic coating, comparable to a blanket. The pressure lining 10 is held in a cylinder channel by tensioning devices in a known manner.

For ensuring the economic efficiency of the coating method, the film advance of the transfer film 5 from the film storage roll 8 to the transfer gap 6 and to the film take-up roll 9 can be controlled such that the transfer film 5 is stopped as much as possible when the application of the imaging layer should not or cannot take place, including upon passage of a channel of the impression cylinder. Improved film usage can be achieved when the transfer film 5 is divided into one or more sub-film webs of smaller width.

Within the coating unit 2, the transfer film 5 is guided by film guide rollers 14 to the transfer gap 6 and away from this gap. Openings arranged in guards 15 of the coating unit 2 correspond to the path of film travel.

Additional devices 20, 23 are used for monitoring the guidance and presence of the film web 5 and its web tension. In this way, the control of the printing or transfer process can be enhanced. For this purpose, application unit 1 and coating unit 2 can be linked to a central control console of the printing press. Desired values for the maximum and minimum web tension can be input at the central control console. This can be made dependent on the type of transfer film 5 being used and on the printing or transfer conditions in the coating module 2 in relation to the properties of the printed material, the adhesive, or the pressure lining 10. The necessary data could be read by means of interfaces directly from data carriers on film storage rolls 8, and parameter values of the settings of the transfer process could be changed on the coating module 2.

Furthermore, a printing sheet coated with a metallized layer can further be printed with ink printing in at least one printing unit 50 following the coating unit 2. Here, the printing sheet is transferred out from the coating unit 2 by the impression cylinder 4 via a sheet-transfer drum or a sheet-transfer unit to an impression cylinder 40 of the printing unit 50.

As usual in offset printing units, the printing unit 50 has the impression cylinder 40, an underpackage or blanket cylinder 41 allocated to this impression cylinder, and a plate cylinder 43 allocated to this blanket cylinder. An inking unit and a damping unit, here shown schematically, are allocated to the plate cylinder 43. Another nip 60 is formed between the impression cylinder 40 and the blanket cylinder 41. In this nip 60, a printing ink is applied on the printing sheet from a printing plate 44 mounted on the plate cylinder 43 above a cover 42 arranged on the blanket cylinder 41. In the nip 60, an approximately linear pressure is exerted on the printing sheet, with this pressure also acting on the image parts of the metallic coating. Here, the pressure in the nip 60 is matched to the pressure provided in the transfer gap 6.

For controlling the process sequences, in this case a machine controller is provided in each printing press. This controller prepares all of the possible settings for the printing unit 50 and also the printing units of the printing press that form the coating unit 2 and the application unit 1.

Furthermore, in connection with the machine controller, according to the invention, a control device is provided on which an interface to a color measurement system is provided, with this device being used for monitoring the print quality of the printed and coated printing sheets. Here, measurements are performed optically on the printing sheets with printed color measurement or color control fields with respect to their density or colorimetric diffuse reflection. The measurement values are used for controlling and regulating the ink supply of the printing units of the printing press. Thus, the device forms a color measurement and regulation system.

The color measurement or color control fields referred to above are typically constructed in a kind of control strip and arranged at the beginning or end across the entire printed width of the printing sheet, and thus, can be easily scanned on the color measurement system and detected with respect to measurements. Likewise, a special arrangement of color control fields in a local distribution across a printing sheet can be used, especially in the field of package printing. Such color control fields can be distributed like strips in regions of the printing sheet that are not needed for use. Alternatively, printing quality data can be detected in the region of image positions of the printing so that no color control fields are required.

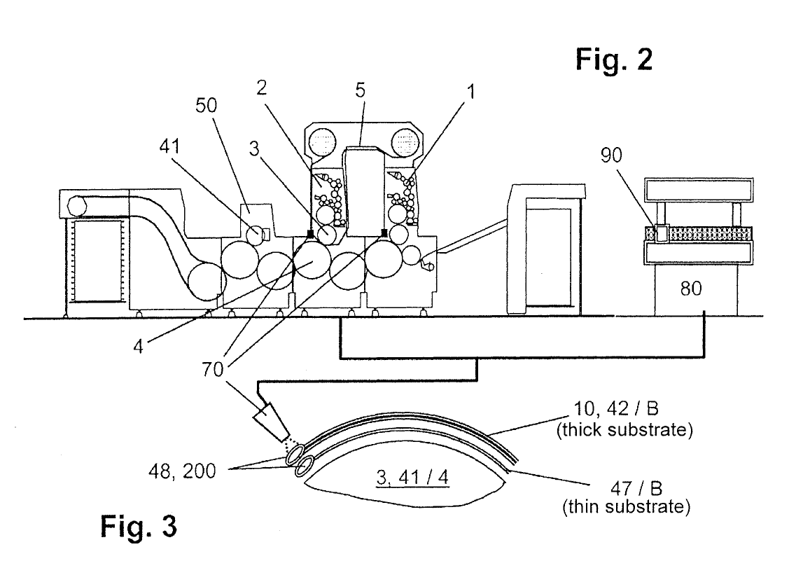

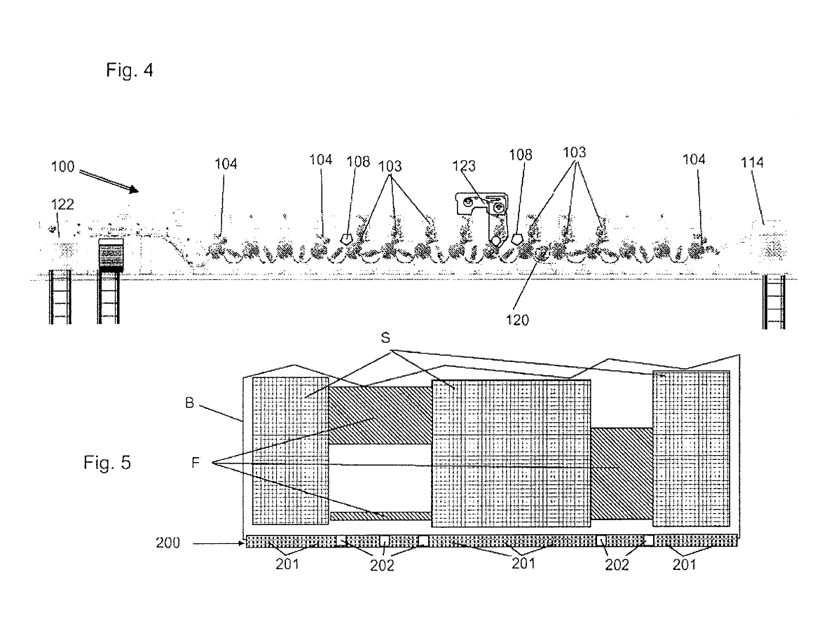

Color measurement systems for a densitometric or colorimetric detection of printing quality data on printed substrates could be arranged within printing presses as offline measurement systems, such as the device 90, as depicted in FIG. 2 that is separate from the printing process next to the printing press or as inline measurement systems (17 in FIG. 1; 70 in FIGS. 2 and 3; 108 in FIG. 4), that perform online measurements in the printing process.

During the printing production, in one case, the quality measurement values are measured with the help of the offline measurement system 90 (see FIG. 2) on individually tensioned printing patterns and transmitted to the machine controller or the controller for the ink guidance of the printing press 100.

On the other hand, the measurement values in the inline measurement system 17 (see FIG. 1), 70 (see FIGS. 2 and 3), 108 (see FIG. 4) are measured constantly for continuous printing processing on the newly printed specimens and then transmitted to the machine controller or the controller for the ink guidance of the printing press 100, for example, in connection with a control panel 80 (see FIG. 2).

For setting the printing press for the method of the cold-film transfer, corresponding settings are very useful in all of the printing units that are to be provided with a coating medium, wherein these settings are derived from a control process by the color measurement and regulation system.

For ensuring a good quality printing or coating, it is further possible to control and regulate the setting of the ink supply to printing units 103, 50 that are arranged subsequent to the assemblies 1, 2, 123 for the cold-film transfer, so that ink is dosed to these printing units 103, 50 based on the measurement results of the color measurement and regulation system.

For controlling the printing press according to the invention, the data evaluation of the color measurement and regulation system from the quality measurement is likewise used for the adhesive application in the application unit 1, 123. For this purpose, specific control fields 202 are provided for the bonding agent or the adhesive. As indicated in FIG. 5, these fields can be arranged in the region of or in common with color control strips 200 having color measurement fields 201 for the other inks to be printed on the printing sheet B. Therefore, the control fields 202 can be measured for the bonding agent or the adhesive simultaneously with the color measurement fields 201 of the other inks. The setting of the adhesive feed in the application unit 1, 123 can be automated in this way so that a large amount of expensive waste can be spared while starting up the method of the cold-film transfer.

In the embodiment of FIG. 5, the control fields 202 are allocated only to the regions of the film application that is shown here as film subject F. The film subject F also corresponds to the adhesive image or adhesive subject that is deposited in the application unit 1. The printed image or printing subject S is independent of the adhesive subject. The color control fields 201 are therefore arranged across the entire width of the printed sheet B in the printing control strip 200.

For ensuring bonding of the transfer layer that is to be transmitted from the transfer film onto the substrate, a substance similar to a printing ink can be used for the image-related application on the substrate as a bonding agent or as an adhesive. This bonding agent or adhesive could be, in principle, a pigment-free, thus, colorless printing ink.

The printing ink used as a bonding agent or adhesive may be colored, for example, matching the color of the film layer to be transferred. In this way, additional color effects can be generated or the base color of the film layer could be emphasized visually. Here, the color of the bonding agent or adhesive could also be selected so that it can be easily detected using measurements. As will be understood below in connection with the preliminary setting of the printing press 100, the parameter values of the adhesive can be matched to the planned cold-film transfer. For the measurement, an optimum quantity of adhesive is determined as a desired value, from whose specification it can be determined online and in the control loop whether sufficient adhesive is provided for a secure bonding of the film on the printing sheet B or whether somewhat too little or too much adhesive is present, so that poor adhesion or a poor coating image is to be expected due to excess adhesive.

In order for the control fields 202 to be detected reliably, it can be provided that no film transfer be carried out in the region of the control fields 202. This procedure also allows the control fields 202 to be measured inline during the production process and thus a continuous quality control can be performed together with the printing ink.

For the purpose of preventing film transfer in the region of the control fields 202, the pressure lining 10 used for the film transfer could be eliminated on the pressure roller 3 in the regions of the control fields for the adhesive, so that the transfer film is not pressed onto the substrate when running over these regions and thus no film transfer is performed.

Other possible applications of the method of the present invention are depicted in connection with embodiments of FIGS. 2 and 3. In FIG. 2, the printing unit 50 is shown as a coating module, but is also to be considered functionally as a printing unit. Therefore, instead of the separate coating module, a printing unit or multiple printing units could also be used.

For the coating process, the impression pressure or the effective pressure acting in the transfer gap 6 or the nip 60 can be changed by changing the contact position of a rubber cylinder or changing the lining of the pressure roller 3 or the blanket cylinder 41. For this purpose it is known that so-called underlayment sheets 47 on the corresponding cylinder 3 or 41 are allocated to the pressure lining 10 or a blanket/underpackage 42. Its change leads to an increase or decrease in the gap dimension in the corresponding effective gap 6, 60 when the relative position of the corresponding cylinder 3, 41 is not changed relative to the impression cylinder 4, 40. The final measure of the diameter of the cylinder 4, 40 combined with the mounted linings (pressure lining 10 or blanket/underpackage 42, optional underlayment sheet 47) is dependent on the thickness of the linings. Therefore the dimensions of the thickness of the pressure linings 10, the blankets/underpackages 42 and the underlayment sheet 47 can be read or entered manually or automatically into the machine controller.

According to the embodiment of FIG. 3, a readable marking 48 for functional data, such as the magnitude of its thickness dimension, could be provided on the pressure linings 10, the blankets/underpackages 42, and the underlayment sheet 47. The reading or identification of the data can be performed with corresponding aids. Suitable reading devices 70 could be arranged in or outside of the printing press or in connection with control arrangements. Here, the reading devices 70 could also be connected above or within the machine controller to a central control console 80 or a printing tower of the printing press.

With the same arrangement as depicted in FIG. 3, the color measurement device can also detect control fields 202 in the printing control strip 200 as shown in FIG. 5. The reading devices 70 could then be arranged inline and the control fields on the printing sheet B (shown here also alternatively as thin and thick substrates) could be measured on the impression cylinder 4.

The data transfer to the machine controller and the storage of the data that sets the relative position of the pressure roller 3 and the blanket cylinder 41 to the corresponding impression cylinders 4, 40 can be performed by conventional means. A corresponding situation applies in connection with the measurement of color densities/color values at this position.

In light of the growing importance of inline color measurement and regulation systems, as well as register measurement and regulation systems, in general the color measurement and regulation can be connected as an inline process to a system for the inline color measurement and regulation. For this purpose, defined machine configurations and procedures are needed. Therefore, by means of a printing press according to FIG. 4, the adhesive can be set up and controlled automatically. In this way, sample sheets do not have to be pulled through, and the printing press does not have to be stopped for control and regulation processes. Instead, the cold-film transfer can be performed, and the printing sheet coated in this way can still be printed or coated.

As indicated above, a printing control strip 200 can lie in the film-free region of the printing sheet B. This printing control strip 200 can be measured inline and the inking can be regulated with the obtained values. By means of an expanded, special inline color measurement and regulation system that is expanded by functions for the gloss measurement and film detection in the measurement box, the printing sheet B coated with the film subject F and then printed and optionally coated is measured and the inking can be regulated accordingly.

By means of a special evaluation element on the printing sheet for the quality of the film transfer with respect to surface quality, transmission accuracy, and adhesion of the transfer layer on the printing sheet, additional evaluations could be performed with respect to the printing process and could be used for the measurement and regulation of the printing process and the film transfer process.

The goal, as in the already standardized color and register regulation of the printing ink, is to realize an interrupt-free production with automated measurement and regulation in an inline process also during operation with cold-film transfer.

With an inline inspection system 17, as indicated in FIG. 1, quality monitoring can be localized only in the sense of defects or the like and waste sheets can be optionally ejected or marked. Therefore, in FIG. 1, instead of the inspection system 17, an inline color measurement device could also be provided. The inline measurement and regulation method offers further automation and production steps for achieving and ensuring quality.

In the printing press 100 depicted in FIG. 4, for supplying the printing press 100 with printed material, a feeder mechanism is provided that consists of a stack conveyor in connection with a feeder 114 and automatic stack feeding to the printing press 100. Furthermore, for discharging printed material from the printing press 100, a delivery mechanism is provided in connection with a delivery unit 122 and a stack transport system for transport from the delivery unit 122 into storage or to further processing.

The printing units 103 are constructed as offset printing units and are adapted for automated operation. For this purpose, devices are provided here that allow all settings and supply of operating materials to be performed without manual interventions.

In the printing units 103 of the printing press 100 there are automated inking and damping units that are equipped with devices for settings that can be remotely controlled and regulated for lifting cycles, rubbing inserts and travels, selectable roller separation positions, variations of the ductor rotational speed, etc. An automated ink and adhesive supply could be added to this as a line system or by means of cartridges directly on the ink box of each printing unit 103.

Optionally, in each of the printing units 103, the plate cylinders (form cylinders) of the printing presses 100 are each provided with a direct drive independent of the main drive. For the use of such a drive configuration, simultaneous washing functions can be carried out by means of corresponding controllers and/or simultaneous first-running inking programs and/or application changes on the fly could be performed.

Furthermore, in the printing press 100, one or more coating units 104 are connected before, between, or after the printing units 103. The configuration could be constructed as a coating module or inline coating unit on the printing unit. In coating units, an automatic coating supply is further provided that includes the heating of the coating and/or viscosity regulation system for the coating.

An automated format-sheet setting is already known. For this purpose, on a blanket or form cylinder of a printing unit 103, a lower packing made from a flexible carrier material is provided. On this material, at intervals, several underlayment forms are arranged. The packing can move by tensioning shafts on the cylinder periphery so that an underlayment form can be positioned relative to the upper packing. Such a device can also be used in a device for the cold-film transfer in order to allow format-related application for the coating with film material.

For the preparation of the further processing, the infeed and the positioning of punching or stamping forms in a printing unit 103 or in a coating module 104 can be effected through automatic and semi-automatic change systems. These change systems can also be used for coating plates or for pressure linings in the coating unit 123.

In the printing press 100, a sheet-turning device 120 is provided that allows for automated front-side and back-side printing of printing sheets and their repositioning for the printing press 100 from the fine-printing mode to the perfecting mode and also vice versa.

Quality monitoring can be performed by means of inline inspection systems and/or inline densitometry measurement devices 108. These can be arranged optionally as inline color density measurement and regulation devices or as inspection systems before and after a sheet-turning device 120, in order to be able to detect and evaluate both printed sides of the printed materials during the perfecting mode. The measurement systems 108 also are equipped for the measurement of colorimetric measurement values or for the inspection of coatings or film coatings as these are generated by the cold-film transfer system.

Finally, the machine central control console is equipped with storage functions for all of the printing press and application-related setting and measurement values so that these can be recalled for repeated applications. The machine central control console and the machine controller are further characterized by integration into a printer network with the preliminary stages, logistics, material supply, additional printing presses, and preliminary and post processing. On the printing press, in connection with all of the previously named functions, quick-start devices with starting procedures for inking units, damping units, printing units, sheet feeding, sheet delivery, waste supply and delivery, coupling of the feeder, etc., are provided.

A method that can be executed with such a device is applied in the printing press according to the invention, in particular, a sheet-fed, offset rotary printing press with several printing, coating, and post-processing units. It contains the steps explained below.

The set-up procedure of the printing press 100 for the production start is performed automatically under the use of preliminary stage data, data of the printing material, data of the current or a previously processed, similar printing application. For this purpose, a transmission of all of the process data from the work preparation to the machine central control console or the machine controller is performed for the preliminary machine setting with respect to the data of the printed material, the subject, the printing inks, and the coating being used, as well as other production options that can be carried out in the printing press. For this purpose, the use of machine-specific data is also performed for the optimization of the printing quality, such as, for example, the input and detection of degrees of wear of machine elements, such as rollers in inking and damping units, the use of self-learning programs for the inking preliminary setting and the damping means setting. Here, the self-learning programs learn from the changing of preliminary setting data under certain processing conditions (depending on the type of printing material, printing ink, ink quantity, subject, and other parameters) how printing should be performed advantageously in a certain machine under certain initial conditions and modifies stored characteristic curves for the appearance of similar parameters for a new printing application.

In this connection, specific data for the application of the bonding agent or the adhesive is determined and prepared. Here, it is taken into consideration how much adhesive is required in order to be able to process, for certain printing materials, in turn, differently defined film layers. Furthermore it is taken into consideration how the overall visual effect of the adhesive and film layers should look. Furthermore, the type of adhesive or its composition is specified and set with respect to the measurement values that can be determined visually from this composition.

For monitoring the quality during the printing production, automated sequences are used in that the color density and/or the adhesive density and/or the film application is measured inline or offline and optionally the printing sheets B are simultaneously subjected to defect inspection. These procedures are performed with an evaluation of full-tone surfaces for printing defects, such as streak formation, sweeping, doubling, and with respect to color consistency.

The color consistency is advantageously determined in that spot growth, doubling, and shifting are detected using measurements on grid surfaces. The determination of color consistency is carried out by means of integrated color control with an inline densitometer and color regulation system.

In connection with the color measurement and regulation, the automated damping with correction of the damping-means supply is carried out as a function of inking-in and the corresponding operating state of the printing press, as well as external parameters. Furthermore, quality control is carried out by register measurement/regulation. In addition, the register accuracy in the sheet-fed system and printing unit is determined. A back-edge register is evaluated when a sheet-turning procedure is carried out.

Finally, quality control is performed with respect to the coating with the film. For an inline coating, a coating layer thickness measurement becomes, furthermore in connection with a drier controller, a gloss measurement of the coating surface, detection of the temperature, and detection of the coating viscosity. For the monitoring of the film coating quality, the applied film layer itself can be inspected with respect to structure, edge sharpness, color, smoothness, and adhesion. For this purpose, a separate film control field FK comparable to a color control field could be provided on the printing sheet B.

Optionally, for printing presses 100 with turning device 120 in which printed material is printed on the front and back sides, additional processing steps with additional devices are provided. For example, color matching for the front and back sides of the printed sheet are performed by a double inline measurement and regulation system 108. Here, before the sheet turning 120, the front side of the sheet is measured, and after the completion of the back-side printing, the image of the back side is evaluated. Furthermore, a measurement is performed with the register setting for the production of an exact, so-called turner register. Furthermore, the quality monitoring is performed with respect to smearing and scratches caused by the sheet movements produced during the turning operation. For this purpose, a double inline inspection system is provided that is united automatically with the regulation device of the printing press 100 for the case of the turning operation. The devices are likewise used for the application of the cold-film transfer. Here, the quality and amount of printed adhesive is also monitored inline and used for controlling the application unit 1.

The preliminary setting of the printing press 100 is also improved by a preliminary application setting during a still running printing application.

Finally, a process-data evaluation/storage of process-relevant data and settings should be maintained with peripheral devices for repeated applications in the machine controller. The process data is treated as follows:
Neutral setting values in the processing mode with optimization and/or adjustment data adapted to the printing press and the current processing;
For special printing presses, preliminary setting with selected control parameters; these are processed in the printing process in the control loop for quality optimization and for maintaining the process stability, e.g., by monitoring temperature and/or roller pressure and/or cylinder pressure, e.g., by testing the strip width between the ink and damping-agent application rollers for the pressure plate, also expanded as a function of printing and cleaning processes.

The device of a cold-film transfer process can be performed as follows:

a) Draw transfer film 5 in coating module 2

b) Fill bonding agent/adhesive in application unit 1

c) Load preliminary setting for adhesive dosing in film subject F from preliminary stage

d) Perform sample printing/coating

e) Measure control fields 202 inline or offline

f) Comparison of the desired vs. the actual color value/color-density value of control fields 202

g) Tuning of the adhesive dosing

h) Starting of the production process with film transfer in coating module 2 and ink supply to additional printing units 103, 50

i) Measurement of color control fields 201 and correction of ink supply

### LIST OF REFERENCE SYMBOLS

B Printing sheet
DB1 Printing impression adjustment
DB2 Printing impression adjustment
F Film coating/film subject/adhesive subject
1 Application unit
S Print subject/printed image face
2 Coating unit
3 Pressure roller (3′)
4 Impression cylinder
5 Transfer film/film web (5′)
6 Transfer gap (6′)
7 Roller drive
8 Film storage roll
9 Film take-up roll
10 Pressure lining
11 Inking unit
12 Plate cylinder
13 Rubber cylinder
14 Film guide roller
15 Printing unit protection
16 Drier
17 Inspection device/inline color measurement system
18 Dancer roller
19—
20 Film control/film tear monitoring
23 Web tension measurement
40 Impression cylinder
41 Blanket cylinder
42 Underpackage/blanket
43 Plate cylinder
44 Printing plate
45 Positioning device
46 Positioning device
47 Underpackage sheet
48 Control marking
50 Printing unit
60 Nip
70 Control device/inline color measurement system/color density measurement system
80 Control panel/quality control table
90 Offline color measurement system/color density measurement system
100 Printing press
103 Printing unit
104 Coating module/punching module/stamping module
108 Inline color measurement system/color density measurement system
114 Feed
122 Delivery
123 Cold-film transfer
200 Pressure control strip
201 Color measurement field
202 Control field

1-7. (canceled)

8. A multi-color printing machine comprising:
a plurality of printing units;
one of said printing units functioning as an application unit for coating image areas onto printed sheets with an adhesive pattern;
one of said printing units functioning as a coating unit for transferring an image forming layer of a transfer film to the printed sheets, said coating unit including an impression cylinder and a pressure roller that defines a sheet passage and transfer nip; a supply of transfer film having a multi-layer structure including a carrier layer and an image forming layer, a transfer foil guiding device for guiding the transfer foil through the sheet passage and transfer nip with the carrier layer of the transfer foil in contacting relation to the press cylinder under pressure for transferring the image forming layer of the transfer foil to the adhesive pattern on the printing sheets, and
said application unit having a dosing device for providing a controlled supply of adhesive for application to printed sheets, and a control for controlling the dosing device such that the adhesive supply can be regulated during operation of the coating unit and printing machine.

9. The printing machine of claim 8 including at least one printing unit arranged downstream of the coating unit for the transfer of printing ink or lacquer onto the printing sheets coated with the image forming layer of the transfer film.

10. The printing machine of claim 8 in which said control includes an adhesive detection device for measuring adhesive applied to the printing sheets in said application unit, and said control being responsive to measurements of adhesive by the detection device for changing the controlled supply of adhesive to said printing sheets in said application unit.

11. The printing machine of claim 8 in which said adhesive is colored, and said control includes a color measurement device for detecting the color of the adhesive applied to the printing sheets, and said control is operable in response to the color detected by the color measurement device for changing the supply of adhesive in the application unit during operation of the application unit and printing machine.

12. The printing machine of claim 11 in which said application unit provides color control fields of adhesive onto the printing sheets.

13. The printing machine of claim 12 in which said transfer film is formed such that no image forming area is transferred to the color control fields of adhesive in the coating unit.

14. The printing machine of claim 11 in which the color measurement device is disposed for detecting the color of the adhesive while the printing sheet is on the impression cylinder of the coating unit.

15. The printing machine of claim 11 in which said color measurement device is disposed for detecting the color of the adhesive at a location after the transfer of the image forming layer onto the adhesive pattern.

16. The printing machine of claim 8 in which one of said coating units and one of said application units are disposed after a printing unit.

17. The printing machine of claim 8 including a sheet turning device, and one of said application units and one of said coating units are disposed downstream of said sheet turning device.

18. The printing machine of claim 8 in which said printing units are rotary offset sheet printing units which each include a plate cylinder and an impression cylinder.

19. The printing machine of claim 18 including a plurality of transfer cylinders for transferring printed sheets between the impression cylinders of successive printing units.
